(19) United States
(12) Patent Application Publication
(10) Pub. No.: US 2006/0043130 A1
(43) Pub. Date: Mar. 2, 2006

(54) Cargo carrier

(76) Inventor: Gary P. Dabrowski, Landenberg, PA (US)

Correspondence Address: Richard C. Litman;LITMAN LAW OFFICES, LTD., P.O. Box 15035, Arlington, VA, 22215, US

(21) Appl. No.: 10/929,786

(22) Filed: Aug. 31, 2004

(51) Int. Cl. B60R 9/00

(52) U.S. Cl. 224/328

(57) ABSTRACT

The cargo carrier is a monocoque hollow shell enclosure designed to carry cargo without substantially adding aerodynamic drag to an automobile. The carrier is installed on top of an appropriate motor vehicle and has a smooth outer surface and is in the shape of an airfoil, preferably a symmetrical airfoil, which minimizes aerodynamic drag. The top of the cargo carrier includes an access door attached by a hinge to the cargo carrier. The cargo carrier has two mounting members on either side, which sit in a support frame attached to factory installed roof rack rails, thus supporting the cargo carrier above the vehicle.

### BACKGROUND OF THE INVENTION

1. Field of the Invention

The present invention relates to a cargo carrier that can be mounted on the top of an automobile and that is shaped to minimize aerodynamic drag. The cargo carrier is supported above the roof of an automobile and has a profile shape defining a nearly symmetrical airfoil.

2. Description of the Related Art

Drivers often need to transport luggage, sports equipment, and/or camping gear or the like, which cannot be stored in the interior or in the trunk of a vehicle. Rooftop cargo containers and rack systems have been used to transport these bulky items for drivers, but these bulky cargo carriers increase the air drag on the vehicle, thus reducing fuel efficiency.

German Patent No. 1,939,154, published Feb. 11, 1972, discloses a bulky luggage box supported above an automobile. The luggage box has a non-airfoil shape with blunt front and rear ends, a flat bottom side, and a nearly flat upper side.

The majority of luggage boxes for motor vehicles are adapted to sit directly against, or in close proximity to, the roof of an automobile. These bulky luggage boxes result in considerable aerodynamic drag and thus significantly reduce the fuel efficiency of the automobile. Patents disclosing such luggage boxes include U.S. Pat. No. 6,234,371, issued May 22, 2001 to J. Sinn; U.S. Pat. No. 5,713,498, issued Feb. 3, 1998 to C. Cucci; U.S. Pat. No. 4,974,766, issued Dec. 4, 1990 to DiPalma et al.; U.S. Pat. No. 3,095,129, issued Jun. 25, 1963 to R. W. Kerr; U.S. Design Pat. No. 326,634, issued Jun. 2, 1992 to J. Seaver; German Patent No. 2,048,462, published Apr. 6, 1972; and French Patent No. 2,695,890, published Mar. 25, 1994.

Various roof rack systems have been used to help drivers store and transport items that will not fit within the interior or the truck of a vehicle. Patents disclosing such roof rack systems include U.S. Pat. No. 6,561,397, issued May 13, 2003 to Bauer et al.; U.S. Pat. No. 5,282,560, issued Feb. 1, 1994 to R. Ozog; U.S. Pat. No. 5,174,484, issued Dec. 29, 1992 to J. Bott; and U.S. Design Pat. No. 406,557, issued Mar. 9, 1999 to G. Bentley.

None of the above inventions and patents, taken either singly or in combination, is seen to describe the instant invention as claimed. Thus, a cargo carrier solving the aforementioned problems is desired.

### SUMMARY OF THE INVENTION

The cargo carrier is a monocoque hollow shell enclosure designed to carry cargo without substantially adding aerodynamic drag to an automobile. It is installed on top of an appropriate motor vehicle. The cargo carrier has a smooth outer surface and is in the shape of an airfoil, preferably a symmetric airfoil, which minimizes aerodynamic drag. The top of the cargo carrier includes an access door attached by a hinge to the cargo carrier. The cargo carrier has two mounting members extending to each side, which sit in a support frame attached to factory installed roof rack rails, thus supporting the cargo carrier above the vehicle.

The support frame has four uprights having clamps at their base for attachment to the roof-mounted rack rails, and bearing members attached to the top of each upright journalled to receive the mounting members extending from the cargo carrier. When installed onto an automobile, the base of each upright is clamped onto the automobile's roof rack rails and carrier's support members are inserted through the bearing members. A crossbar connects a pair of uprights on each side of the vehicle, giving stability to the support frame.

These and other features of the present invention will become readily apparent upon further review of the following specification and drawings.

### BRIEF DESCRIPTION OF THE DRAWINGS

FIG. 1 is an environmental, perspective view of a cargo carrier according to the present invention.

FIG. 2 is an environmental side view of the cargo carrier of the present invention.

FIG. 3 is an environmental rear view of the cargo carrier of the present invention.

FIG. 4 is a top view of the cargo carrier of the present invention.

FIG. 5 is a perspective view of a support structure for the cargo carrier of the present invention.

FIG. 6 is a side view of the support structure of FIG. 5.

FIG. 7 is an end view of the support structure of FIG. 5.

Similar reference characters denote corresponding features consistently throughout the attached drawings.

### DETAILED DESCRIPTION OF THE PREFERRED EMBODIMENTS

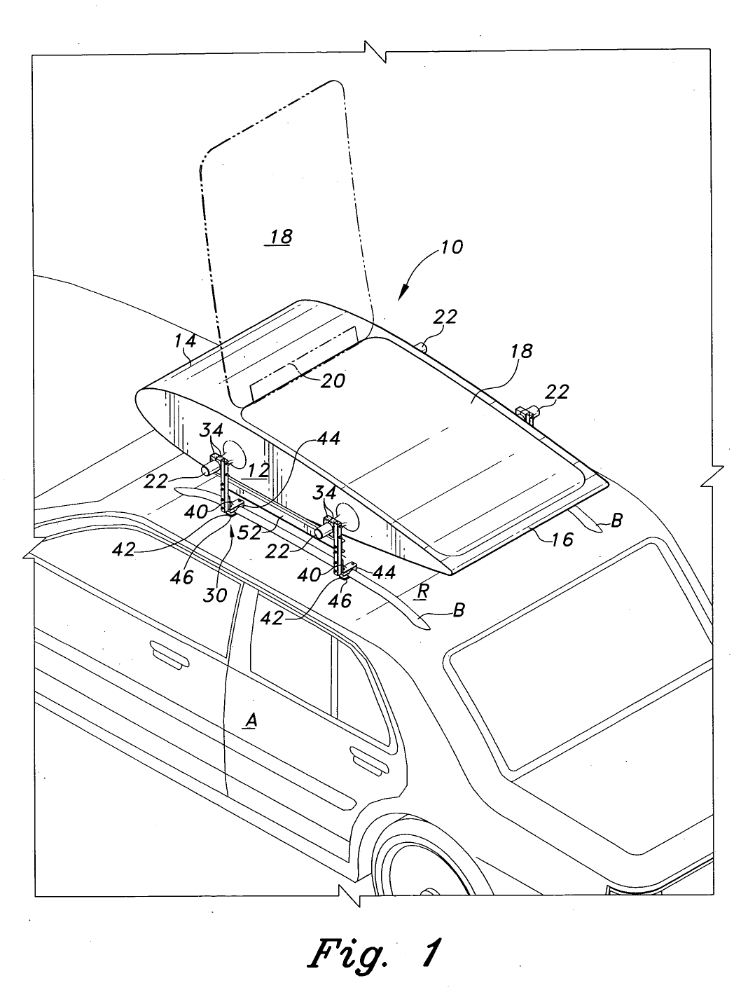

As depicted in FIG. 1, the present invention is a cargo carrier, generally indicated as 10, adapted to be supported above the roof of an automobile A to carry luggage, sports equipment and/or camping gear while providing minimal aerodynamic drag to the automobile A. The cargo carrier 10 has a main body 12 having an airfoil cross-sectional shape. An airfoil shape is a shape designed to control stability, direction, lift, thrust, or propulsion. An airfoil generally has a blunt leading edge, smooth top and bottom surfaces, and a relatively sharp trailing edge. It is desired in the present invention to provide a cargo carrier 10 with an airfoil shaped and oriented to minimize the disruption of air flowing around the cargo carrier 10, thus minimizing aerodynamic drag. The front end 14 (the leading edge) of the main body 12 has a larger radius of curvature than the rear end 16 (the trailing edge) of the main body 12, or the rear end 16 may come to a point as viewed from the side. The front end 14 is oriented towards the front end of the automobile.

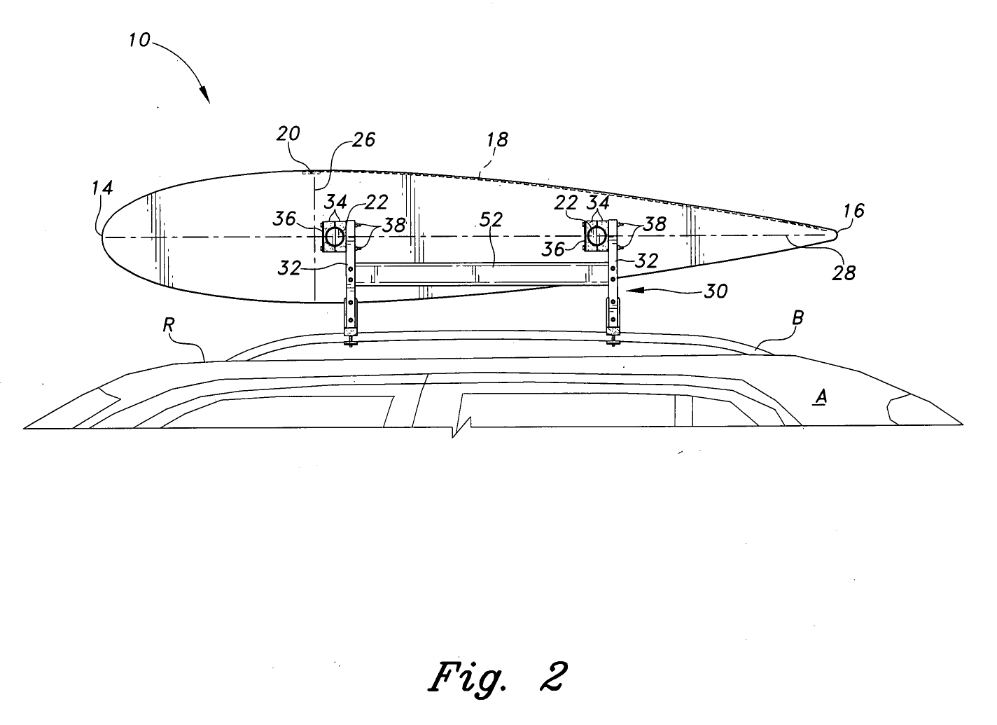

A door 18 is attached to the main body 12 by a hinge 20, permitting a user to access the hollow chamber defined within the main body 12 to insert or remove objects to be stored and transported within the cargo carrier 10. The hinge 20 is preferably positioned at the portion of the door 18 that is nearest to the front end 14 of the main body 12. The hinge 20 is positioned in or behind a plane (indicated by dashed line 26 in FIG. 2) normal to the chord of the main body 12 that extends through the maximum height of the main body 12.

Each side of the cargo carrier 10 includes two mounting members 22 extending laterally from the main body 12. The mounting members 22 fit into apertures journalled in the two side support assemblies 30, which are each attached to the standard roof rails B of the automobile A. The mounting members 22 are depicted as cylindrical, but may be provided with a more aerodynamic shape. The apertures defined in the support assemblies 30 generally conform to the cross sectional shape of the mounting members 22. The mounting members 22 are sufficiently long to allow the cargo carrier 10 to be placed on a variety of automobiles A with vertical roof rails B spaced at different standard intervals. It is also possible to adapt the side support assemblies 30 to support the cargo carrier 10 above an automobile A having different roof rail arrangements, including horizontal roof rails.

As depicted in FIG. 2, the cargo carrier 10 preferably has a substantially symmetrical airfoil shape. An airfoil shape is based upon aircraft airfoil data, which define airfoil cross-sectional shapes. Airfoils may be designed and oriented to create lift or a downward force, but such up or down forces also create aerodynamic drag. It is thus the goal of this invention to provide a cargo carrier that provides negligible upward or downward force so that the aerodynamic drag is minimized. A symmetrical airfoil shape is one in which the bottom portion of the airfoil is the mirror image of the top portion of the airfoil. A symmetrical airfoil shape oriented at a zero degree angle of attack is the optimal shape and orientation for minimizing aerodynamic drag.

Viewed from the side, an airfoil has a curved leading edge and pointed trailing edge. Airfoils are described by their chord, mean camber, thickness, and thickness distribution. The chord line is a straight line joining the leading edge to the trailing edge, designated as line 28 for the airfoil shape depicted in FIG. 2. In a symmetrical airfoil, the distance from the chord line 28 to the upper surface is the same as the distance from the chord to the lower surface at every point along the chord. The mean camber line is the curvature of the median line of the profile of the airfoil.

An airfoil also has a stagnation point, which is the point on the airfoil body where an airstream directed at the leading edge of the wing has a velocity equal to zero, usually where the air stream divides to travel above and below the airfoil. The stagnation point is not fixed, but changes with the angle of attack, i.e., the angle between the chord and the velocity of the air stream. The shape of the airfoil and its orientation relative to airflow will determine the degree of lift or down force, which both create aerodynamic drag. The cargo carrier 10 has an airfoil shape designed to minimize aerodynamic drag and thus creates minimal lift or down force. Thus, the cargo carrier 10 is preferably designed to be oriented with a zero degree angle of attack, and therefore the chord 28 is oriented substantially parallel to the relative ground line.

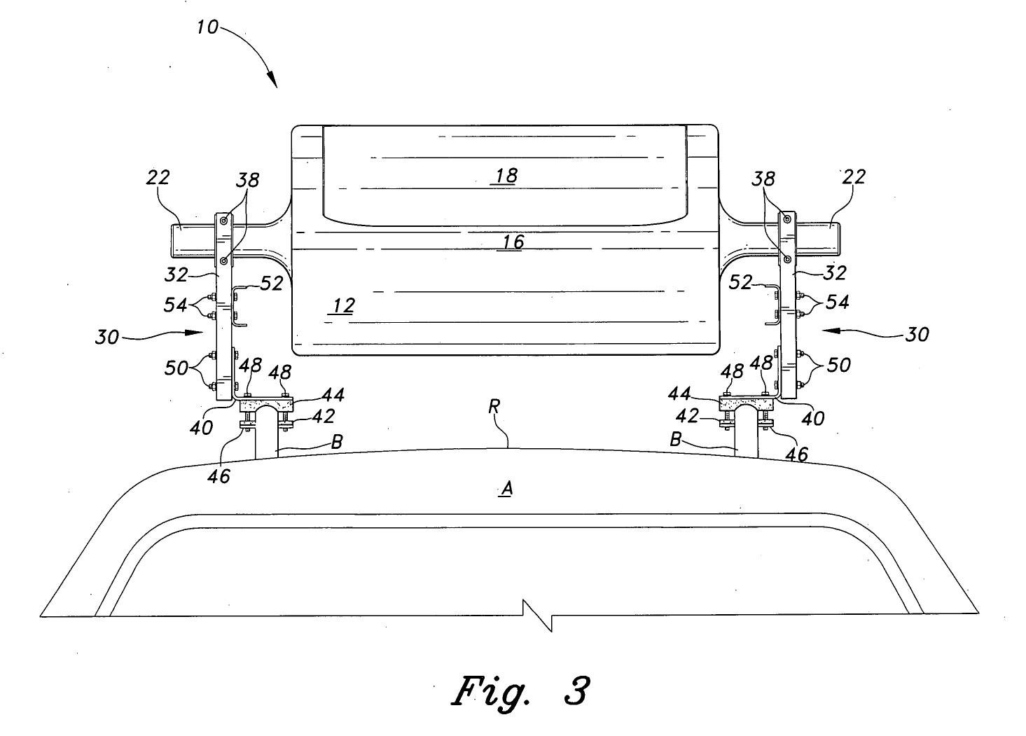

As depicted in FIGS. 1-4, the main body 12 may have a NACA0017 symmetrical airfoil shape, which has a maximum thickness that is seventeen percent of the chord length. (In the National Advisory Committee for Aeronautics (NACA) system of designation, the first digit is the maximum camber in percent of chord, the second digit is the location of the position of maximum camber in tenths of chord measured from the leading edge, and the last two figures represent the maximum thickness in percent of chord.) Alternatively, the main body 12 may have other symmetrical or near symmetrical airfoil shapes, such as the airfoil defined by the NACA 0018 airfoil or a symmetrical laminar airfoil shape, which has the point of maximum thickness (depicted by line 26 in FIG. 3) closer to the rear end 16 of the airfoil.

FIG. 3 shows a rear view of the cargo carrier 10 supported above an automobile A. The main body 12 is shown having a constant cross-sectional symmetrical airfoil shape with flat sides, but the main body 12 may vary in cross-sectional size, as long as every vertical cross section of the main body 12 has an airfoil shape, preferably a symmetric airfoil shape. For example, the main body 12 could have a larger cross-sectional symmetric airfoil shape in the middle and gradually decrease in size towards the sides.

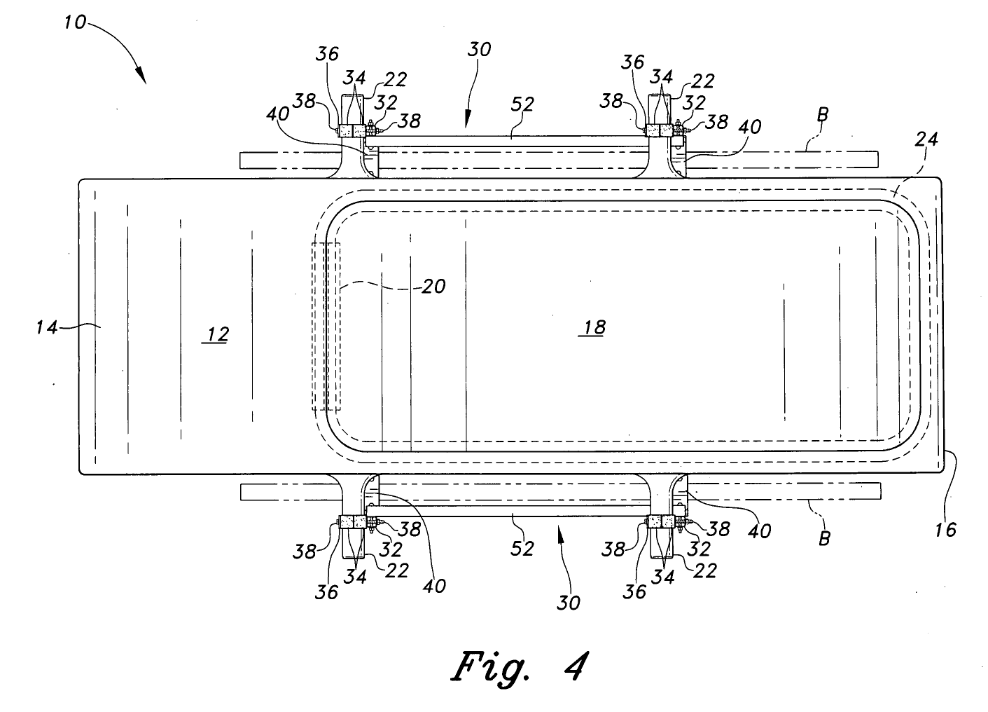

FIG. 4 shows a top view of the cargo carrier 10. The hinge 20 of the door 18 is attached within the hollow cavity of the main body 12 towards the front end 14 of the main body 12. The main body 12 defines an opening corresponding to the shape of the door 18 so that when the door 18 is in a closed position, the hollow cavity is completely encased. A shelf 24 is provided along the inside periphery of the aperture. The periphery of the door 18 rests on the shelf 24 such that the door 18 is flush with the upper surface of the main body 12. The shelf 24 is preferably integral with the main body 12 of the cargo carrier 10, and may have a seal attached thereto for watertight integrity.

The cargo carrier 10 could be made in a variety of sizes, but one optimal design has a length of 84.34 inches, a main body 12 width of 28.12 inches, a maximum thickness of 14.72 inches, and mounting members 22 that each extend from the sides of the main body 12 by 7.94 inches. The distance between each mounting member 22 on each side is preferably about 30.1 inches. It has been found that this size cargo carrier 10 would fit on most automobiles and would accommodate a variety of luggage sizes and sports equipment, but smaller and larger sizes are also anticipated.

The cargo carrier 10 is preferably made out of fiberglass, but may also be made of any sufficiently rigid material including aluminum, other metals, and various plastics.

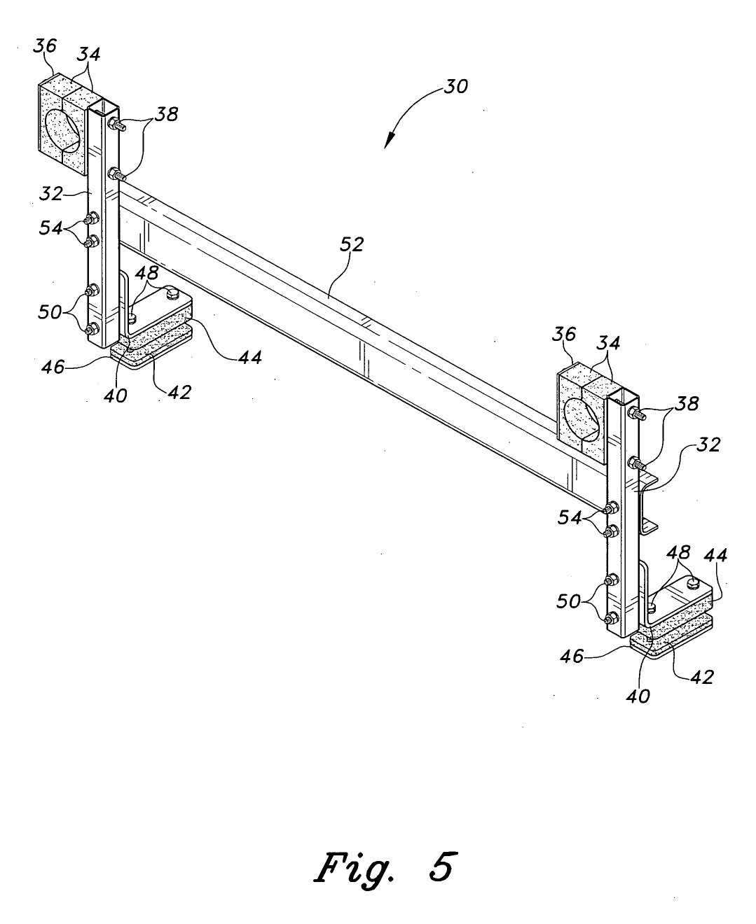

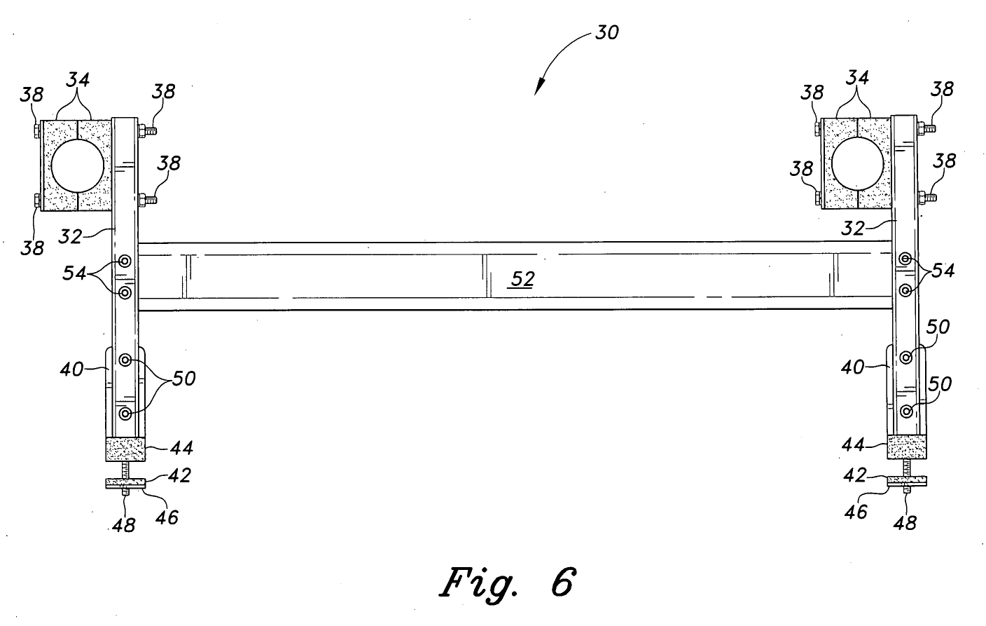

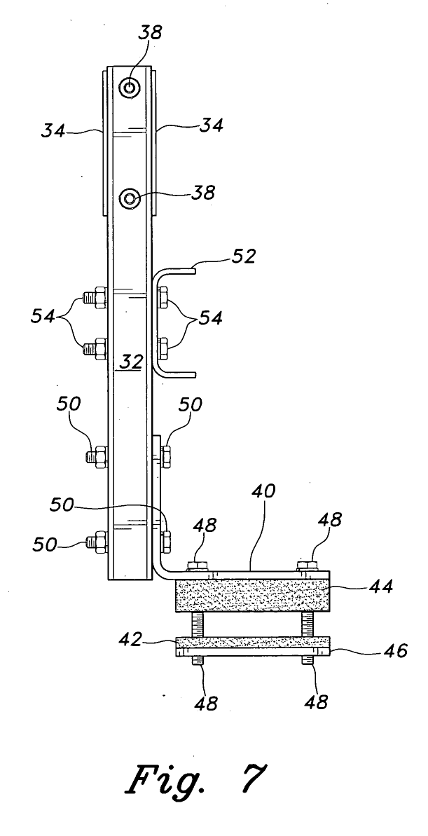

FIGS. 5-7 depict a side support assembly 30 in detail. FIG. 5 is a perspective view, FIG. 6 is a side view, and FIG. 7 is an end view of the side support assembly 30. The side support assembly 30 preferably includes two spaced uprights 32 each having a top end and a bottom end. The uprights 32 are preferably fixed in the desired spaced relationship by a crossbar 52. The crossbar 52 adds stability to the support frame 30 and fixes the two uprights 32 in the exact spacing of the two carrier protrusions 22 on each side of the cargo carrier 10. The crossbar 52 is attached to the uprights 32 at each end by two bolts 54.

Each upright 32 has a two-piece bearing block 34 attached to its upper end. The bearing blocks 34 are journalled to the cross-sectional shape of the mounting members 22, defining circular apertures. Bolts 38 are used to secure the bearing blocks 34 to the upper end of each upright 32. The bearing blocks 34 optionally include a front plate 36. The bearing blocks 34 are sufficiently thick to properly support the cargo carrier 10 above the automobile. The bearing blocks 34 and front place 36 of the present invention are sold by ZSi Corporation under the trade name BETA CLAMP.

An L-shaped bracket 40 is attached to the bottom end of each upright 32 by bolts 50. The second leg of the L-shaped bracket 40 extends normal to the upright 32 and is approximately flush with the bottom end of the upright 32. A lower clamping face 46 is attached below the second leg of the L-shaped bracket 40 by two clamping bolts 48. The upper side of the lower clamping face 46 is provided with a bottom compression layer 42 and the lower side of the second leg of the L-shaped bracket 40 is provided with a top compression layer 44. The compression layers 42 and 44, or gaskets, are of a compressible semi-soft rubber or other suitable easily compressible layer of material that will securely grip the roof rail B, thereby clamping the support assembly 30 to the roof rail B. The top compression layer 44 is preferably thicker than the bottom compression layer 42 because roof rails B usually have substantially flat bottom surfaces and varying top surfaces. The top compression layer 44 is preferably two to four times thicker than the bottom compression layer 42.

It is to be understood that the present invention is not limited to the embodiments described above, but encompasses any and all embodiments within the scope of the following claims.

I claim:

1. A cargo carrier for mounting on the roof of an automobile, comprising:
a main body having a monocoque outer surface, the main body including a top surface, a bottom surface and two side surfaces defining a hollow interior chamber, the top and bottom surfaces defining an airfoil cross-sectional shape;
a door pivotally attached to the main body for providing access to the hollow interior chamber through the outer surface.

2. The cargo carrier according to claim 1, wherein the top and bottom surfaces define a substantially symmetrical airfoil cross-sectional shape.

3. The cargo carrier according to claim 1, further comprising means for supporting the cargo carrier elevated above the roof of the automobile.

4. The cargo carrier according to claim 1, further comprising at least one mounting member extending from each of the side surfaces of said main body.

5. The cargo carrier according to claim 4, further comprising two side support assemblies, wherein each of said side support assemblies has means for clamping the assemblies to a vehicle roof rail and means for holding said mounting members.

6. The cargo carrier according to claim 1, further comprising:
a first pair of spaced apart mounting members extending from one of the sides of said main body and a second pair of mounting members extending from the other side of said main body; and
a first support assembly and a second support assembly adapted for attachment to roof rails on opposite sides of the roof of the automobile, each of the support assemblies having:
a first upright and a second upright, each of the uprights having an upper end and a lower end;
a bearing block attached to the upper end of each of the uprights, the mounting members being journalled in the bearing blocks; and
a clamp attached to the lower end of each of the uprights.

7. The cargo carrier according to claim 6, wherein each of said mounting members comprises a cylindrical shaft.

8. The cargo carrier according to claim 6, wherein each said bearing block comprises a first member and a second member, said mounting member being sandwiched between the first and second member.

9. The cargo carrier according to claim 8, further comprising at least one fastener extending through the first and second members of said bearing block and through said upright for securing said bearing to said upright.

10. The cargo carrier according to claim 6, wherein each said clamp comprises:
an L-shaped bracket having a first leg attached to said upright and a second leg extending normal to said upright; and
an lower clamping face removably attached to the second leg, the roof rail being clamped therebetween.

11. The cargo carrier according to claim 10, further comprising at least one gasket disposed between the second leg of said L-shaped bracket and said lower clamping face.

12. The cargo carrier according to claim 11, wherein said gasket is made from rubber or other compressible material.

13. The cargo carrier according to claim 6, wherein each said support assembly further comprises a crossbar extending between said first and second uprights and rigidly maintaining said first and second uprights in spaced relation.

14. The cargo carrier according to claim 1, wherein said main body defines a shape in section corresponding to NACA designation NACA0017.

15. The cargo carrier according to claim 14, further comprising means for mounting the main body above the roof of the automobile at an angle of attack of zero degrees.

16. The cargo carrier according to claim 1, further comprising means for mounting the main body above the roof of the automobile at an angle of attack of zero degrees.
